(19) United States
(12) Patent Application Publication
(10) Pub. No.: US 2016/0008113 A1
(43) Pub. Date: Jan. 14, 2016

(54) DENTAL FLOSS AND METHODS OF MAINTAINING ORAL HYGIENE

(71) Applicant: Daniela Spector, Great Neck, NY (US)

(72) Inventor: Daniela Spector, Great Neck, NY (US)

(21) Appl. No.: 14/660,564

(22) Filed: Mar. 17, 2015

Related U.S. Application Data
(60) Provisional application No. 61/954,314, filed on Mar. 17, 2014.

(51) Int. Cl. A61C 15/04

(52) U.S. Cl. CPC A61C 15/042

(57) ABSTRACT

The present technology relates to improved dental flosses and dental tapes and methods of improving oral hygiene and oral health. A dental floss according to the technology herein comprises expandable filament having a first end and a second end, wherein one or both of the first end or second end comprises a loop into which a human finger can be inserted, the expandable filament having a substantially rough outer surface.

### BACKGROUND

The present technology relates to oral care and oral hygiene devices and methods, in particular to an improved dental floss for maintaining superior oral hygiene.

Dental diseases such as gum disease and tooth decay can be caused by the buildup of bacteria, plaque and other materials such as food particles on the surfaces of the teeth. Brushing alone is often not adequate to remove the bacteria from all of the surfaces, particularly hard-to-reach surfaces in the back of the mouth and between the teeth. Dental professionals often recommend dental floss or dental tape to clean such surfaces and improve overall oral hygiene.

Dental floss or dental tape is, at its simplest, a filament (or bundle of filaments) that fits between two teeth and is used to sweep material out from between the teeth. Brushing and flossing are together generally encouraged as an effective way of maintaining oral health and hygiene.

However, in some instances dental floss or dental tape is too thin and brittle, or too easily shredded or broken to provide adequate cleaning action, in particular where there are larger than usual spaces between the teeth (for example, in the case of unevenly spaced teeth, or where the subject has experienced gum disease and bone loss). In other instances, there can be a need for more textured dental floss or dental tape, or for dental floss or dental tape that has a larger surface area, for example when a user has particularly heavy plaque or bacteria buildup or desires an extra amount of cleaning of surfaces between the teeth.

Thus, a need exists for improved dental floss or dental tape that are adequate to improve oral health and hygiene for a variety of needs of a variety of users.

### SUMMARY OF THE DISCLOSED TECHNOLOGY

In certain embodiments, the present technology is directed to a dental floss comprising a length of expandable filament having a first end and a second end, wherein one or both of the first end or second end comprises a loop into which a human finger can be inserted, the expandable filament having a substantially rough outer surface.

In certain embodiments, the present technology is directed to a method of flossing teeth, the method comprising: (a) inserting between two teeth a length of dental floss comprising an expandable filament having a first end and a second end, one or both of the first end or second end comprising a loop into which a human finger can be inserted, the expandable filament having a substantially rough outer surface; and (b) moving the length of dental floss along the surfaces of the teeth.

In certain embodiments, the present technology is directed to a method of flossing teeth, the method comprising: (a) obtaining a length of dental floss comprising an expandable filament having a first end and a second end, one or both of the first end or second end comprising a loop into which a human finger can be inserted, the expandable filament having a substantially rough outer surface; (b) inserting a finger into the loop and gripping the dental floss; and (c) inserting the dental floss between two teeth.

In certain embodiments, the present technology is directed to methods of improving oral hygiene or oral health.

### BRIEF DESCRIPTION OF THE DRAWINGS

FIG. 1 shows an exemplary length of dental floss in accordance with certain embodiments of the technology herein.

FIG. 2A and 2B show exemplary surfaces of the dental floss in accordance with certain embodiments of the technology herein.

### DETAILED DESCRIPTION

The present technology relates to improved dental floss or dental tape, as well as to methods of improving oral health and oral hygiene.

As used herein, the terms “dental floss,” “floss” and “dental tape” are used interchangeably, and both refer to any material comprising a filament that can be grasped in the hands and inserted into spaces between the teeth. As used herein, “filament” means any thin string, thread or rope made of any material that can be used to make dental floss or dental tape for sweeping surfaces of the teeth, particularly between teeth. Filaments useful for the present technology can include any combination of one or more filaments, depending on the thickness and strength desired for the dental floss. In certain embodiments, a dental floss according to the technology herein comprise two or more filaments held together. In other embodiments, a dental floss according to the technology herein comprises only one single filament and no more.

As used herein, the words “tooth” and “teeth” refer to the tooth or teeth of any mammal, including but not limited to a human.

In certain embodiments, the dental floss comprises an expandable filament. As used herein, “expandable” means exhibiting highly stretchable properties, such that a user can pull on it and stretch it lengthwise, crosswise or both. In various embodiments, the dental floss comprises a filament that, when pulled, can lengthen to a length that is up to about 500%, up to about 450%, up to about 400%, up to about 300%, up to 250%, up to about 200%, up to about 150% or up to about 125% of its resting (unstretched) length.

Suitable materials for the filament include, but are not limited to: yarns, fabric thread, or polymers, including rubbers or plastics such as thermoplastics and thermoplastic elastomers. In certain embodiments, the filament comprises poly(p-phenylene oxide) (PPO) or poly(p-phenylene ether (PPE) or a blend comprising either of the foregoing. In certain embodiments, the filament comprises any fluorocarbon solid such as a fluoropolymer of tetrafluoroethylene, including but not limited to polytetrafluoroethylene (PTFE), or perfluoroalkoxy (PFA) or fluorinated ethylene propylene (FEP). In certain embodiments, the plastic is formed by injection molding or extrusion, in a range of about 260 to about 300 degrees C. the present technology may also be manufactured through additive processes or 3D printing.

In certain embodiments, at least part of the outer surface of the filament is substantially smooth. As used herein, “substantially smooth” means that the surface appears smooth to the naked eye, and is visibly free of projections. In other embodiments, at least part of the outer surface of the filament is substantially rough. As used herein, “substantially rough outer surface” means that at least part of the surface does not appear smooth to the naked eye, in that it appears to have one or more projections or indentations, or other inconsistencies on its surface that prevent it from being characterized as a “substantially smooth outer surface.”

In certain embodiments, at least part of the surface of the filament is substantially rough in that it comprises one or more projections. In various embodiments, the projections give the outer surface of the filament a textured surface; or increase the surface area of the dental floss, therefore further improving its ability to remove bacteria, plaque, trapped food and other unwanted matter from the surface of a tooth. For example, in certain embodiments, the filament's outer surface can include small, outward projections that comprise materials the same as, or with similar properties as, the material of the filament itself, and give the filament an “hairy,” “furry” or “fuzzy” texture, providing a slightly rougher surface for contacting with the teeth and sweeping away unwanted matter. In other embodiments, the filament's outer surface can include other projections that are raised areas such as bumps, ridges, welds or studs, giving, for example, a “bumpy” or “pimply” texture. In certain embodiments, these are integral to the filament or manufactured separately from the filament. In certain embodiments, the projections can be manufactured in a mold. In certain embodiments, these can be formed with a heating element, friction or welding such as ultrasonic welding, or the raised areas can be attached to the surface of the filament, for example with glue, solvents (including halogenated solvents) or other adhesives.

In certain embodiments, the projections or indentations can be pulled, flattened or distorted by the action of pulling on the filament in a lengthening direction—that is, when held from one or both of its ends and pulled in a manner that increases the separation of the two ends and lengthens the filament. In other embodiments, the projections or indentations are such that lengthening the filament has substantially no effect on the size or amount of protrusion of the projections, or intrusion of the indentations.

In certain embodiments, a dental floss is provided that comprises a filament having a predetermined length, and a first end and a second end, wherein one or both of the ends comprises a loop, configured such that a finger can be inserted into the loop to facilitate use of the dental floss to move between the teeth. In various embodiments, the dental floss can be packaged in such a manner as to provide a plurality of lengths of dental floss, each comprising at least one loop, such that a user can easily obtain a length of dental floss for use. In other embodiments, the dental floss is provided in one single length, for example, in a roll, and the user can cut the desired length of the dental floss before use. In certain embodiments, the one or more loops are pre-formed in the dental floss at certain points along its length, such that the user can cut the dental floss at the appropriate points along its length to provide multiple lengths of dental floss having at least one loop on an endpoint. In such embodiments, before use by the user, the filaments can be said to be at their “resting” (unstretched) length.

The presence of the one or more loop, along with the stretchy characteristics of the filament, provide advantages to the user, including the ability to obtain a piece of dental floss quickly, to use it quickly by inserting a finger into a loop, and to use less floss than would be needed with a less stretchy and flexible piece of floss. That is, a relatively short length of floss can be used to floss a relatively large surface area. The length of floss can be pulled out and used to floss the teeth, after which the ends can be released and the floss allowed to tighten back into its original length, providing less waste for discarding.

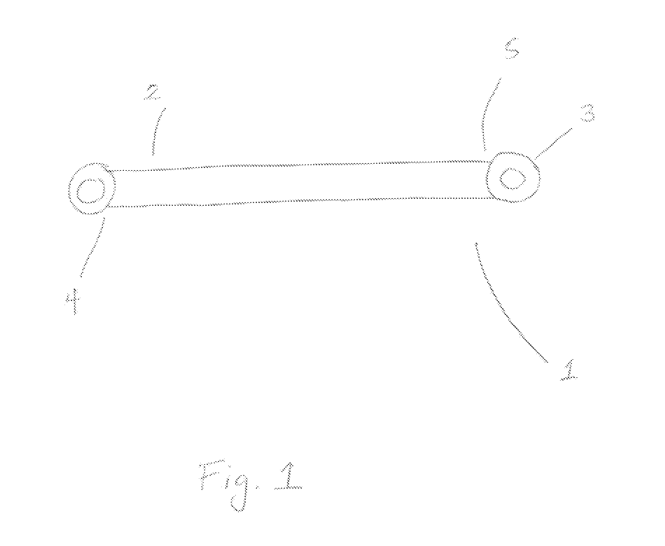

FIG. 1 shows an exemplary length of dental floss according to certain embodiments of the present technology. The dental floss 1 comprises a filament 2 with one or more loops 3 on the one or both of the first endpoint 4 or second endpoint 5. In the embodiment shown in FIG. 1, the outer surface of the filament is relatively smooth.

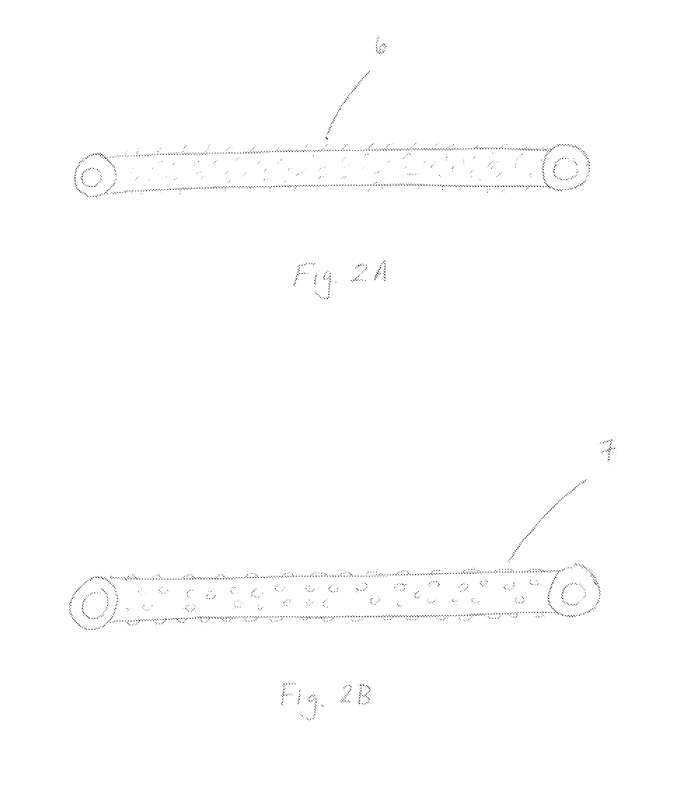

FIGS. 2A and 2B show other exemplary embodiments. In FIG. 2A, the outer surface of the filament comprises projections 6 that give it a “hairy,” “furry” or “fuzzy” texture. In FIG. 2B, the outer surface of the filament comprises projections 7 that give it a “bumpy” or “pimply” texture. In other embodiments not shown in the Figures, the projections are ridges; in other embodiments, they are indentations and can comprise troughs, channels, dimples or the like.

In certain embodiments, the technology herein is directed to a method of improving oral hygiene or oral health. As used herein, “improving oral hygiene or oral health” means creating a positive environment in the oral cavity in reducing the presence of plaque, bacteria and trapped food. Any action in accordance with the present methods and materials that reduces the presence of any of these items constitutes an improvement of oral hygiene and oral health.

Although the present technology has been described in relation to particular embodiments thereof, these embodiments and examples are merely exemplary and not intended to be limiting. It will be apparent to one of ordinary skill in the art that aspects of the technology, as described above, can be implemented in many different forms. The operation, manufacture and behavior of the aspects described herein were described without reference to the specific things understood by one of ordinary skill in the art. The present technology should, therefore, not be limited by the specific disclosure herein, and can be embodied in other forms not explicitly described here, without departing from the spirit thereof.

What is claimed:

1. A dental floss comprising a length of expandable filament having a first end and a second end, wherein one or both of the first end or second end comprises a loop into which a human finger can be inserted, the expandable filament having a substantially rough outer surface.

2. The dental floss of claim 1, wherein the outer surface of the filament comprises one or more projections.

3. The dental floss of claim 1, wherein both of the first end and second end comprise a loop into which a human finger can be inserted.

4. The dental floss of claim 1, wherein the expandable filament is capable of being stretched to a length of up to about 500% of its resting length.

5. The dental floss of claim 1, wherein the expandable filament has an outer surface comprising one or more projections.

6. The dental floss of claim 1, wherein the expandable filament comprises poly(p-phenylene oxide) (PPO), poly(p-phenylene ether (PPE), polytetrafluoroethylene (PTFE), perfluoroalkoxy (PFA), fluorinated ethylene propylene (FEP) or a blend of any of the foregoing.

7. A method of flossing teeth, the method comprising:
(a) inserting between two teeth a length of dental floss comprising an expandable filament having a first end and a second end, one or both of the first end or second end comprising a loop into which a human finger can be inserted, the expandable filament having a substantially rough outer a surface; and
(b) moving the length of dental floss along the surfaces of the teeth.

8. The method of claim 7, further comprising the step of expanding the filament to a length of up to about 500% of its resting length.

9. A method of flossing teeth, the method comprising:
(a) obtaining a length of dental floss comprising an expandable filament having a first end and a second end, one or both of the first end or second end comprising a loop into which a human finger can be inserted, the expandable filament having a substantially rough outer surface;
(b) inserting a finger into the loop and gripping the dental floss; and
(c) inserting the dental floss between two teeth.

10. The method of claim 10, further comprising the step of expanding the filament to a length of up to about 500% of its resting length.

11. A method of improving oral health or hygiene, the method comprising
(a) obtaining a length of dental floss according to claim 1;
(b) inserting a finger into the loop and gripping the dental floss; and
(c) inserting the dental floss between two teeth.
